(19) United States
(12) Patent Application Publication
(10) Pub. No.: US 2026/0289998 A1
(43) Pub. Date: Sep. 24, 2026

(54) INFORMATION PROCESSING DEVICE, OBJECT RECOGNIZING METHOD, AND NON-TRANSITORY COMPUTER-READABLE MEDIUM

(71) Applicant: NEC CORPORATION, Tokyo (JP)

(72) Inventors: Akira TSUJI, Tokyo (JP); Jiro ABE, Tokyo (JP)

(73) Assignee: NEC Corporation, Tokyo (JP)

(21) Appl. No.: 19/478,417

(22) PCT Filed: May 24, 2023
(86) PCT No.: PCT/JP2023/019322

§ 371 Date: Oct. 24, 2025

(51) Int. Cl. G06V 10/70

(52) U.S. Cl. CPC G06V 10/87

(57) ABSTRACT

The purpose of the present invention is to provide an information processing device capable of improving recognition accuracy of an object. The information processing device includes a recognition unit that recognizes a plurality of objects present in a predetermined space included in image data by using a first recognition model and a second recognition model, a selection unit that selects which of a recognition result in the first recognition model and a recognition result in the second recognition model is to be used for each of the objects, and a generation unit that generates recognition data including the selected recognition result of each of the objects, and the first recognition model recognizes the object on the basis of a positional relationship among the objects, while the second recognition model recognizes the object on the basis of a shape of the object.

### TECHNICAL FIELD

The present disclosure relates to an information processing device, an object recognizing method, and a non-transitory computer-readable medium.

### BACKGROUND ART

In order to efficiently perform work in a facility such as a substation, a worker who performs the work needs information regarding what kind of object is arranged in the facility and further information regarding arrangement of objects in the facility.

PTL 1 discloses a configuration of an object recognizing device that enables to precisely confirm a shape and an attitude of owned equipment on a computer, using three-dimensional shape data measured in an infrastructure facility. Specifically, PTL 1 discloses a configuration of an object recognizing device that recognizes a shape of an object, using a measurement point cloud and a model point cloud. The object recognizing device recognizes an object by performing matching between the measurement point cloud and the model point cloud having a same shape attribute such as a flat surface or a straight line.

### CITATION LIST

### Patent Literature

PTL 1: WO 2014/155715 A1

### SUMMARY OF INVENTION

### Technical Problem

However, since the object recognizing device in PTL 1 performs matching using the shape attribute, the object recognizing device is not allowed to recognize objects having a same shape between the measurement point cloud and the model point cloud but having different applications. As a result, the object recognizing device in PTL 1 has a difficulty that the accuracy of matching may be likely to deteriorate.

In view of the above problems, an object of the present disclosure is to provide an information processing device, an object recognizing method, and a non-transitory computer-readable medium capable of improving object recognition accuracy.

### Solution to Problem

An information processing device according to a first aspect of the present disclosure includes a recognition unit for recognizing at least one object present in a predetermined space included in image data by using a first recognition model and a second recognition model, a selection unit for selecting which of a recognition result of the first recognition model and a recognition result of the second recognition model is to be used, for each of the objects, and a generation unit for generating recognition data including the selected recognition result on each of the objects, in which the first recognition model recognizes the object, based on a positional relationship between the objects, while the second recognition model recognizes the object, based on a shape of the object.

An object recognizing method according to a second aspect of the present disclosure includes recognizing at least one object present in a predetermined space included in image data by using a first recognition model and a second recognition model, selecting which of a recognition result of the first recognition model and a recognition result of the second recognition model is to be used, for each of the objects, and generating recognition data including the selected recognition result on each of the objects, in which the first recognition model recognizes the object, based on a positional relationship between the objects, while the second recognition model recognizes the object, based on a shape of the object.

A non-transitory computer-readable medium according to a third aspect of the present disclosure stores a program for causing a computer to execute recognizing at least one object present in a predetermined space included in image data by using a first recognition model and a second recognition model, selecting which of a recognition result of the first recognition model and a recognition result of the second recognition model is to be used, for each of the objects, and generating recognition data including the selected recognition result on each of the objects, in which the first recognition model recognizes the object, based on a positional relationship between the objects, while the second recognition model recognizes the object, based on a shape of the object.

### Advantageous Effects of Invention

According to the present disclosure, an information processing device, an object recognizing method, and a non-transitory computer-readable medium capable of improving object recognition accuracy can be provided.

### BRIEF DESCRIPTION OF DRAWINGS

FIG. 1 is a configuration diagram of an information processing device according to the present disclosure.

FIG. 2 is a diagram illustrating a flow of an object specifying process executed in the information processing device according to the present disclosure.

FIG. 3 is a configuration diagram of an information processing device according to the present disclosure.

FIG. 4 is a diagram illustrating an example of a recognition process in a recognition model according to the present disclosure.

FIG. 5 is a diagram illustrating a flow of an object specifying process executed in the information processing device according to the present disclosure.

FIG. 6 is a configuration diagram of an information processing device according to the present disclosure.

FIG. 7 is a diagram illustrating a flow of an object specifying process executed in the information processing device according to the present disclosure.

FIG. 8 is a configuration diagram of an information processing device according to the present disclosure.

### FIRST EXAMPLE EMBODIMENT

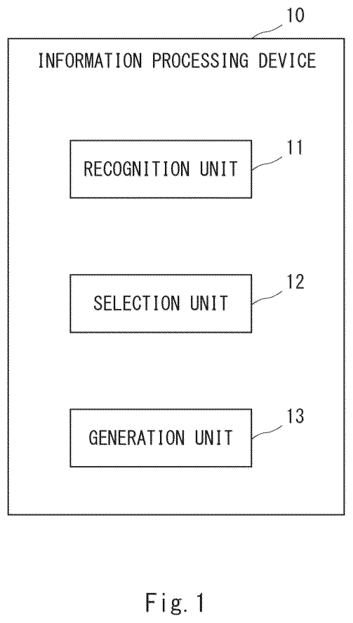

Example embodiments of the present disclosure will be described below with reference to the drawings. A configuration example of an information processing device 10 will be described with reference to FIG. 1. The information processing device 10 may be a computer device that operates by a processor executing a program stored in a memory. Constituent elements such as functional blocks constituting the information processing device 10 may be distributed and arranged in a plurality of information processing devices. The information processing devices may be connected to each other via a network.

The information processing device 10 includes a recognition unit 11, a selection unit 12, and a generation unit 13. The recognition unit 11, the selection unit 12, and the generation unit 13 may be software or modules in which processing is executed by a processor executing a program stored in a memory. Alternatively, the recognition unit 11, the selection unit 12, and the generation unit 13 may be hardware such as circuits or chips.

The recognition unit 11 recognizes at least one object present in a predetermined space included in image data, using a first recognition model and a second recognition model. Recognizing an object means verifying, for each element of minimum unit constituting image data (which denotes a pixel for two-dimensional image data, a point in a case of three-dimensional point cloud data, and a voxel for three-dimensional voxel data; hereinafter, will be expressed as an “element”), what kind of object the element makes up (specifying a name or a category of the object for each element). In general, it is a recognition approach by a technique called semantic segmentation. The predetermined space may be, for example, a closed space in a building or an outdoor open space. In an outdoor open space, for example, a region targeted for recognizing an object may be defined in advance using position information. The position information may be, for example, information indicating latitude and longitude, information such as an address, or information indicating a distance and a direction from a predefined reference point.

The object may be, for example, an object fixedly installed on the ground or a floor, or may be a movable object. The object may include a human, an animal other than a human, a plant, and the like. Furthermore, the object may be a device, a component, or the like arranged in a substation.

The image data may be data generated in an image capturing apparatus, or may be data generated in a sensor for measuring a distance. The image data may be two-dimensional data or three-dimensional data. The data generated in the sensor for measuring a distance may be, for example, point cloud data including points having three-dimensional information. Alternatively, the data generated by the sensor for measuring a distance may be a depth image, a depth map, or the like indicating the depth of the object.

The first recognition model is a model that recognizes an object, based on a positional relationship between objects. The second recognition model is a model that recognizes an object, based on a shape. The recognition model may be referred to as a machine learning model or a trained model. Recognizing an object may mean recognizing a name of the object, a category to which the object belongs, properties of the object, and the like. Recognizing an object may be paraphrased as specifying an object, determining an object, or the like.

Since the first recognition model uses the positional relationship between objects in the course of learning, for example, the first recognition model learns data of the entire facility including a plurality of objects. Therefore, the data size is reduced by processing such as thinning out the data in such a way that the data can be stored in a memory of a calculator. Consequently, learning will be performed with data in which information on the positional relationships between objects is kept, but minute features of the shapes are lost. In the first recognition model, by learning data of the entire facility including a plurality of objects, the object recognition accuracy for an object having a larger size, among the objects included in the data, is more improved. The reason why the object recognition accuracy for an object having a larger size is more improved is that the number of regions or points used for matching objects is expanded as the size of the object is larger, and thus the learning results on these pieces of data in majority are easily reflected in the update of learning parameters. That is, in the first recognition model, the recognition accuracy for an object having a smaller size tends not to be so high as an object having a larger size.

Meanwhile, the second recognition model may divide image data into small regions in such a way as to include an object to be recognized, in order to recognize an object based on its shape of the object. In the second recognition model, by using image data divided into small regions, the object recognition accuracy for an object having a smaller size is more improved. That is, in the second recognition model, the larger the size of the object, the lower the object recognition accuracy. The shape of the object may be a straight line, a curved line, a flat surface, a curved surface, or the like, for example.

The selection unit 12 selects which of the recognition result of the first recognition model and the recognition result of the second recognition model is to be used, for each object. The first recognition model and the second recognition model analyze the same image data. Therefore, the first recognition model and the second recognition model recognize the same object included in the image data. That is, the recognition result on each object included in the image data is output from each of the first recognition model and the second recognition model. Alternatively, the second recognition model may analyze image data obtained by excluding an object recognized by the first recognition model.

The selection unit 12 selects one of the recognition result of the first recognition model and the recognition result of the second recognition model for each object included in the image data. The selection unit 12 may select either the recognition result of the first recognition model or the recognition result of the second recognition model in accordance with a predefined criterion. The criterion may be, for example, the dimensions of the object. Specifically, the selection unit 12 may select the recognition result of the first recognition model in a case where the dimensions of the object are larger than a threshold and select the recognition result of the second recognition model in a case where the dimensions of the object are smaller than the threshold. The criterion is not restricted to the dimensions of the object.

The generation unit 13 generates recognition data including the selected recognition result on each object. The recognition data may be data in which a name of each object, a category to which each object belongs, properties of each object, and the like are specified. Including the recognition result on each object may mean combining each of the recognition results on the objects. The recognition data may be generated as image data. Alternatively, the recognition data may be data in which the position of the object in the image data is associated with the name or the like of the object.

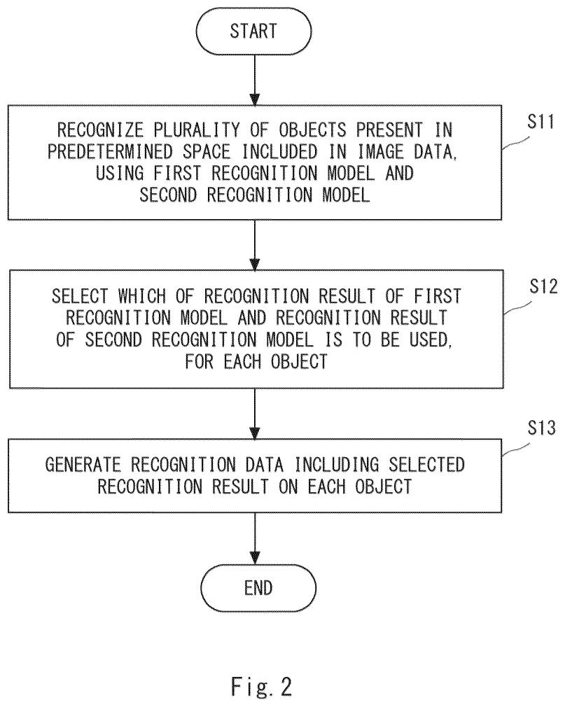

Subsequently, an object recognizing method executed in the information processing device 10 according to the first example embodiment will be described with reference to FIG. 2. First, the recognition unit 11 recognizes a plurality of objects present in a predetermined space included in image data, using the first recognition model and the second recognition model (S11). The first recognition model recognizes an object, based on a positional relationship between objects. The second recognition model recognizes an object, based on a shape of the object.

Next, the selection unit 12 selects which of the recognition result of the first recognition model and the recognition result of the second recognition model is to be used, for each object (S12). Here, each element is in a state in which a result of each recognition model has been obtained. The following method is conceivable in terms of which recognition model's result is to be selected. First, on the recognition result of the first recognition model, the selection unit 12 groups elements verified to be elements of the same object by a clustering process. As a criterion for grouping, a criterion such as a distance between elements lower than a threshold is used. Next, the selection unit 12 computes a spatial extent of each group and adopts the result of the first recognition model if the computed spatial extent is equal to or more than a reference value that is satisfactory for classifying as a large object. The selection unit 12 adopts the results of the second recognition model for the other elements. Next, the generation unit 13 generates recognition data including the selected recognition each of the objects (S13).

As described above, the information processing device 10 includes a plurality of recognition models having different features. Furthermore, the information processing device 10 selects a recognition model to be used for recognition of an object, according to the object included in the image data. As a result, the information processing device 10 can improve the recognition accuracy for a plurality of objects included in the image data by using a recognition model with higher recognition accuracy for each object.

For example, in the first recognition model, it is necessary to thin out data in order to learn a positional relationship between objects as a scale of a facility targeted for recognition rises, and learning is performed with data in which a feature of a shape of each object is lost. Therefore, in case of recognizing each object included in the facility, the selection unit 12 may determine to use the second recognition model of which the recognition accuracy is more improved as the size of the object is smaller. In this manner, the information processing device 10 can improve the recognition accuracy for the entire facility targeted for recognition, by causing one recognition model to execute the recognition process for a region having poor recognition accuracy by another recognition model.

### SECOND EXAMPLE EMBODIMENT

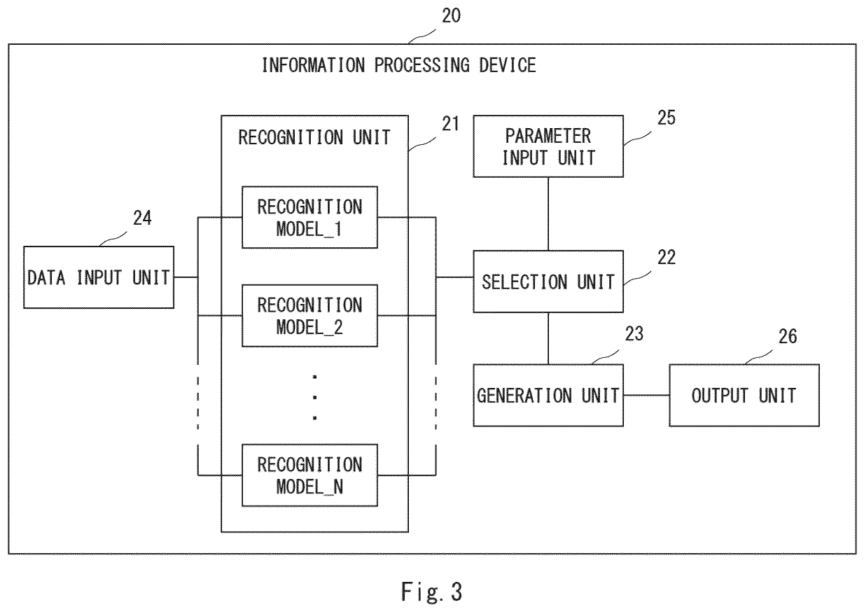

Subsequently, a configuration example of an information processing device 20 will be described with reference to FIG. 3. The information processing device 20 has a configuration in which a data input unit 24, a parameter input unit 25, and an output unit 26 are added to the information processing device 10. The data input unit 24, the parameter input unit 25, and the output unit 26 may be software or modules in which processing is executed by a processor executing a program stored in a memory. Alternatively, the data input unit 24, the parameter input unit 25, and the output unit 26 may be hardware such as circuits or chips.

A recognition unit 21 corresponds to the recognition unit 11 in the information processing device 10. A selection unit 22 corresponds to the selection unit 12 in the information processing device 10. A generation unit 23 corresponds to the generation unit 13 in the information processing device.

The data input unit 24 inputs, for example, point cloud data to the recognition unit 21 as image data. In other words, the data input unit 24 passes the point cloud data to the recognition unit 21. The point cloud data is a set of points having three-dimensional information. The point cloud data may be generated, for example, by a sensor for measuring a distance or an image capturing apparatus. The sensor for measuring a distance may be, for example, a sensor that measures a distance from the sensor to an object, using light detection and ranging (LiDAR). The point cloud data may be generated using distance information measured by the sensor for measuring a distance and position information measured using a global positioning system (GPS).

Various sensors for generating the point cloud data may be mounted on the information processing device 20, or may be connected to the information processing device 20 via a network. The data input unit 24 acquires the point cloud data generated by various sensors.

Alternatively, a user may input the point cloud data generated by various sensors to the information processing device 20 as offline data. The data input unit 24 may generate the point cloud data, using data measured by various sensors.

For example, the point cloud data may be generated using software or the like for generating three-dimensional information using a plurality of pieces of two-dimensional image data.

The recognition unit 21 includes recognition models_1 to N (N is an integer equal to or more than two). The numbers 1 to N are identification information for identifying the recognition models. The recognition models may have features different from each other. For example, the recognition model_1 may be a model that recognizes an object, based on a positional relationship between objects. The recognition model_2 may be a model that recognizes an object, based on a shape.

Each recognition model recognizes a shape of an object including a straight line, a curved line, a flat surface, a curved surface, and the like, for example. Recognizing the shape may mean extracting a feature quantity of the shape. The feature quantity of the shape may be, for example, information indicating that the object has a linear shape, a flat surface shape, or a vertical shape. Specifically, the feature quantity of the shape may be information indicating a length, an area, a volume, a curvature, or the like of the object. In a case where the point cloud data is used, the feature quantity of the shape may be information indicating a spatial distribution such as points distributed in a straight line shape, a flat surface shape, or a vertical shape. In a case where data generated in the image capturing apparatus is used, the feature quantity of the shape may include color information on each pixel, such as red green blue (RGB) information.

For example, each recognition model may extract the feature quantity of the shape from a positional relationship between a certain reference point and a point around the reference point. Furthermore, each recognition model may determine which shape each point included in the point cloud data constitutes.

In other words, each recognition model may determine in which shape of a straight line, a curved line, a flat surface, a curved surface, or the like each point included in the point cloud data is included.

For example, the recognition model_2 may determine which object's point each point included in the point cloud data is, based on the feature quantity of the shape. Specifically, the recognition model_2 may determine that points indicating the shape amount with high flatness are the ground or a floor surface. The recognition model_2 may divide the point cloud data into small pieces in consideration of avoiding the shape features from being impaired and the size of a memory of the information processing device 20 and then recognize an object, using the point cloud data. The recognition model_2 may perform a recognition process using, for example, PointNet.

The recognition model_1 may recognize what kind of object each group makes up, from a positional relationship between groups of points indicating a particular feature. The groups of points indicating a particular feature may be, for example, sets of points indicating the same shape. The group may be paraphrased as a cluster. For example, the recognition model_1 may perform a recognition process using a super point graph.

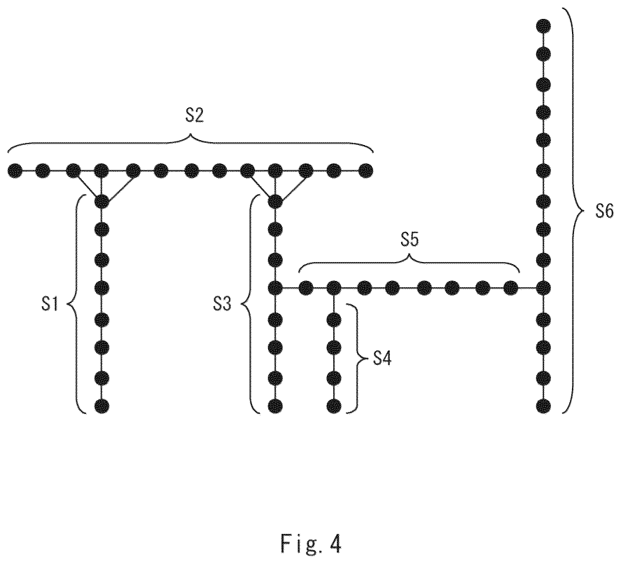

An example of a recognition process in the recognition model 1 will be described with reference to FIG. 4. FIG. 4 illustrates point cloud data relating to a table and a chair. Groups of points are indicated by S1 to S6. The point cloud included in S2 indicates a top plate of the table. The point clouds included in S1 and S3 indicate legs of the table. The point cloud included in S4 indicates a leg of the chair. The point cloud included in S5 indicates a seating face of the chair. The point cloud included in S6 indicates a backrest and a leg of the chair.

The recognition model_1 first recognizes each of the shapes of S1 to S6. For example, the recognition model_1 recognizes that S1, S3, S4, and S6 are point clouds in which points are vertically distributed. Furthermore, the recognition model_1 recognizes that S2 and S5 are point clouds in which points are horizontally distributed. In other words, the recognition model_1 extracts a feature quantity of each of the shapes of S1 to S6.

Next, the recognition model_1 specifies an object of each group, based on a positional relationship between the groups. The recognition model_1 has learned positional relationships between groups in the course of learning. The learning of positional relationships between groups may be executed in, for example, a learner having a gated recurrent unit (GRU) or a long short-term memory (LSTM). The learning of positional relationships between groups may be, for example, to recognize that a group having a horizontal shape in contact with a plurality of groups having a vertical shape is a top plate. The learning of positional relationships between groups may be to recognize that a group having a vertical shape in contact with a group having a horizontal shape is a leg.

Once the point cloud data illustrated in FIG. 4 is input, the recognition model_1 specifies that S1 and S3 are legs of the table and S2 is a top plate of the table. Once the point cloud data illustrated in FIG. 4 is input, the recognition model_1 also specifies that S4 is a leg of the chair, S5 is a seating face of the chair, and S6 is a backrest and a leg.

The recognition model_1 recognizing a table and a chair is an example of a process of recognition. For example, in a case where a group indicating a columnar shape and a cluster indicating a linear shape are in such a positional relationship that they are in contact with each other, the recognition model_1 may specify that these groups are a utility pole and an electric wire. Furthermore, the recognition model_1 may recognize whether pipes or the like having similar shapes in a substation are a pipe for flowing electricity or a pipe used for cooling, according to a position with respect to another object arranged around the pipes.

In order to learn positional relationships between groups, the recognition model_1 needs to use, for example, the point cloud data of the entire facility as input data. The recognition model_1 may sometimes thin out the point cloud data in such a way that the input data can be accommodated in a memory of the information processing device 20. The feature of the shape of each group may be impaired in some cases by thinning out the point cloud data, but the object recognition accuracy in combining each group in the entire facility is improved.

The recognition unit 21 may further include another recognition model_N having a feature different from those of the recognition model_1 and the recognition model_2. Alternatively, the recognition unit 21 may further include a recognition model_N that is a recognition model having a feature similar to that of the recognition model_1 or the recognition model_2 but having a different learning scale or recognition accuracy, for example.

Returning to FIG. 3, the recognition model_1 to the recognition model_N included in the recognition unit 21 each execute a process of recognizing an object included in the point cloud data, using the point cloud data received from the data input unit 24. In other words, the recognition model_1 to the recognition model_N included in the recognition unit 21 execute parallel processing in order to recognize an object included in the point cloud data. For example, the data input unit 24 may duplicate the point cloud data by the number of recognition models. The data input unit 24 may input these duplicated pieces of the point cloud data to the recognition model_1 to the recognition model_N.

The recognition model_1 to the recognition model_N output object recognition results to the selection unit 22. The recognition model_1 to the recognition model_N execute the recognition process, using the same point cloud data. Therefore, the selection unit 22 receives N recognition results on the same object at the maximum.

The selection unit 22 selects one recognition result from among a maximum of N recognition results, for each object. The selection unit 22 selects a recognition result in accordance with a selection criterion received from the parameter input unit 25.

The selection criterion may be, for example, the dimensions of the object. Specifically, the selection criterion may be a threshold for dimensions. The selection unit 22 receives the threshold for dimensions from the parameter input unit 25. The selection unit 22 may select the recognition result received from the recognition model_1 for an object larger than the threshold. The selection unit 22 may select the recognition result received from the recognition model_2 for an object equal to or less than the threshold. The recognition model_1 has a feature of having higher recognition accuracy for an object having a larger size than that for an object having a smaller size. The recognition model_2 has a feature of having higher recognition accuracy for an object having a smaller size than that for an object having a larger size.

It is assumed that the point cloud data input to the recognition unit 21 by the data input unit 24 is, for example, data indicating a facility in a substation. The selection unit 22 may select the recognition results of the recognition model_1 for a transformer, a circuit breaker, a disconnector, a lightning arrester, and the like in the substation on the assumption that they are equipment larger than the threshold. The selection unit 22 may select the recognition results of the recognition model_2 for an insulator, a radiator of a transformer, a pipe for flowing a cooling oil, and the like in the substation on the assumption that they are equipment equal to or less than the threshold.

The generation unit 23 generates recognition data by combining the objects selected by the selection unit 22. The generation unit 23 may generate, for example, image data as the recognition data. In other words, the generation unit 23 may generate image data in which an object included in the point cloud data input to the recognition unit 21 by the data input unit 24 is specified.

The recognition data may be image data to which different colors are applied for each object. The recognition data may also be image data in which the object name is displayed in the region of each object. The recognition data may also be image data in which the same color is applied to the same or similar shapes. The same or similar shapes may be shapes in which a difference between feature quantities of these shapes is within a predetermined range. The recognition data may be three-dimensional data in such a way that the user is allowed to rotate or move the recognition data displayed on a display device.

The output unit 26 displays the recognition data generated by the generation unit 23 on a display unit such as a display. The display unit such as a display may be used integrally with the information processing device 20, or may be a display device connected to the information processing device 20 via a cable, a network, or the like.

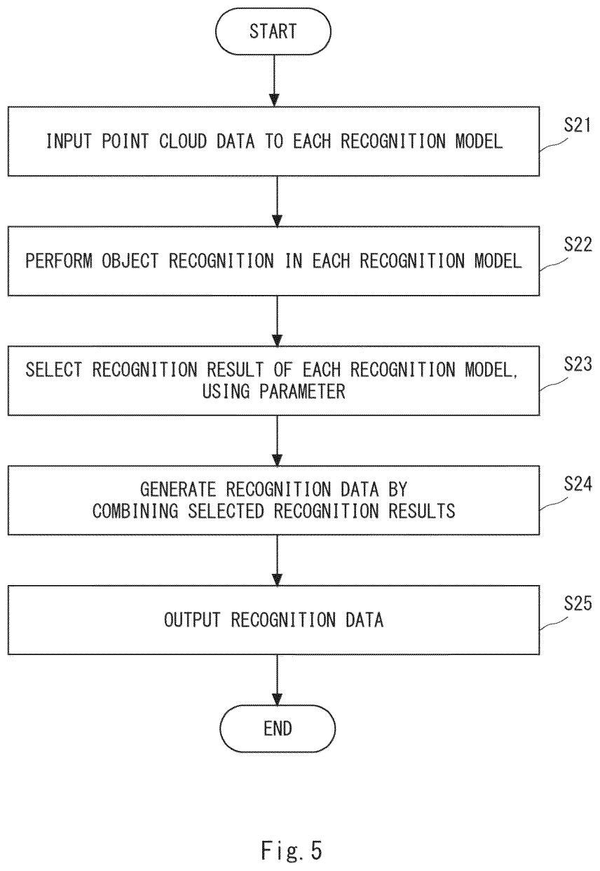

Subsequently, a flow of an object recognition process in the information processing device 20 will be described with reference to FIG. 5. First, the data input unit 24 inputs point cloud data to the recognition unit 21 (S21). For example, the data input unit 24 may duplicate the point cloud data by a number equal to the number of recognition models included in the recognition unit 21. The data input unit 24 may input a plurality of duplicated pieces of the point cloud data to the recognition unit 21.

Next, each of the recognition models included in the recognition unit 21 performs the recognition process on each object included in the point cloud data, using the point cloud data (S22). Each recognition model outputs the recognition results on the objects included in the point cloud data to the selection unit 22.

Next, the selection unit 22 selects a recognition result for each object, using a parameter output from the parameter input unit 25 (S23). Each object is recognized in each recognition model. That is, the recognition results on one object exist as many as the number of recognition models at the maximum. The selection unit 22 selects one recognition result among a plurality of recognition results relating to each object. The parameter may be paraphrased as a selection criterion.

Next, the generation unit 23 generates recognition data by combining the selected recognition results (S24). For example, it is assumed that the selection unit 22 selects the recognition result of the recognition model_1 for an object_A and selects the recognition result of the recognition model_2 for an object_B. The generation unit 23 combines the recognition result of the recognition model_1 relating to the object A and the recognition result of the recognition model_2 relating to the object_B. Combining the recognition results may mean, for example, including a plurality of recognition results in the same image data. That is, the image data generated as the recognition data may include objects recognized by a plurality of recognition models.

Next, the output unit 26 outputs the recognition data to a display unit such as a display (S25). The user is allowed to analyze the recognition data by, for example, rotating or moving the recognition data displayed on the display.

As described above, the information processing device 20 selects one recognition result from a plurality of recognition results output from a plurality of recognition models, according to the dimensions of the object included in the point cloud data. As a result, the information processing device 20 can generate the recognition data in which recognition results with higher recognition accuracy are combined for each object.

In the second example embodiment, the selection unit 22 uses the dimensions of the object as a selection criterion, but the selection criterion is not restricted to the dimensions of the object. The selection unit 22 may select the recognition model, based on a feature of the object other than the dimensions.

For example, the selection unit 22 may separate the recognition models for equipment whose size increases according to the scale of the facility and equipment whose size does not vary regardless of the scale of the facility.

Specifically, the selection unit 22 may be configured in such a way as to select the recognition result of the recognition model 1 for an element recognized by the recognition model 1 as equipment whose size increases according to the scale of the facility and select the recognition results of the recognition model 2 for the other elements because the other elements are equipment whose size does not vary regardless of the scale of the facility.

The parameter input unit 25 may output, to the selection unit 22, information in which equipment whose size increases according to the scale of the facility and equipment whose size does not vary regardless of the scale of the facility are designated. The equipment whose size increases according to the scale of the facility may be an iron structure, an electric wire, and the like in a substation, for example.

The selection unit 22 may separate recognition models for equipment having the same shape but used for different applications and equipment having the same shape and used for the same application. Specifically, the selection unit 22 may be configured in such a way as to select the recognition results of the recognition model 1 for elements recognized by the recognition model 1 as pieces of equipment having the same shape but used for different applications and select the recognition results of the recognition model 2 for the other elements because the other elements are pieces of equipment having the same shape and used for the same application.

The parameter input unit 25 may output, to the selection unit 22, information in which equipment having the same shape but used for different applications and equipment having the same shape and used for the same application are designated. The equipment having the same shape but used for different applications may be pipes and the like in a substation, for example.

The selection unit 22 may be configured in such a way as to select the recognition result of the recognition model 1 for an element recognized by the recognition model 1 as equipment having a simple shape and select the recognition results of the recognition model 2 for the other elements because the other elements are equipment having a complicated shape. Alternatively, the complexity of the shapes may be calculated beforehand to configure in such a way that the result of the recognition model 2 is selected for a region with higher complexity and the result of the recognition model 1 is selected for a region with lower complexity. As the complexity, if the image data is point cloud data, it is conceivable to use a change in direction of a normal vector from the relationship with neighboring elements.

The parameter input unit 25 may output, to the selection unit 22, information in which equipment having a simple shape and equipment having a complicated shape are designated. The equipment having a simple shape may be a pipe for flowing a cooling oil, and the like, for example.

### THIRD EXAMPLE EMBODIMENT

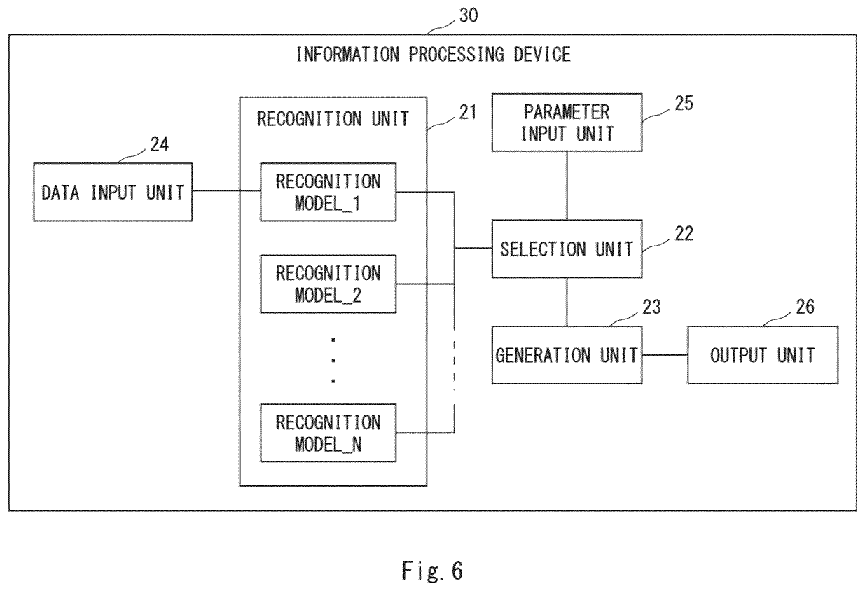

Subsequently, a configuration example of an information processing device 30 will be described with reference to FIG. 6. The information processing device 30 has a configuration in which a data input unit 24 does not input point cloud data to all the recognition models included in a recognition unit 21, but inputs point cloud data to one recognition model included in the recognition unit 21, for example, a recognition model_1. Alternatively, the data input unit 24 may input point cloud data to a selection unit 22. In this case, the selection unit 22 may sequentially input the point cloud data to the recognition model_1 to a recognition model_N.

A parameter input unit 25 outputs, to the selection unit 22, information or a parameter indicating which object is to be recognized using which recognition model. For example, the parameter input unit 25 may recognize a transformer, a circuit breaker, and a disconnector present in a substation, using the recognition model_1. The parameter input unit 25 may output, to the selection unit 22, a parameter indicating that a radiator and a pipe present in the substation are to be recognized using the recognition model_2. The parameter input unit 25 may output, to the selection unit 22, a parameter indicating that equipment other than the transformer, the circuit breaker, the disconnector, the radiator, and the pipe are to be recognized using the recognition model_N (N is an integer equal to or more than three).

The selection unit 22 selects a recognition result on each object among the objects recognized in each recognition model, based on the parameter. The selection unit 22 selects a recognition result on a particular object among the objects recognized in the recognition model_1. The selection unit 22 may output, to the recognition model_2, the point cloud data of an object for which the recognition result has not been selected. The selection unit 22 selects a recognition result on a particular object from among the objects recognized by the recognition model_2. The selection unit 22 may output, to the recognition model_N, the point cloud data of an object for which the recognition result has not been selected. That is, the recognition model_1 to the recognition model_N included in the recognition unit 21 execute series processing in order to recognize objects included in the point cloud data.

The selection unit 22 outputs, to a generation unit 23, the recognition result selected from among the recognition results of the recognition models. Since the processes in the generation unit 23 and an output unit 26 are similar to the processes in the generation unit 23 and the output unit 26 in the information processing device 20, detailed description thereof will be omitted.

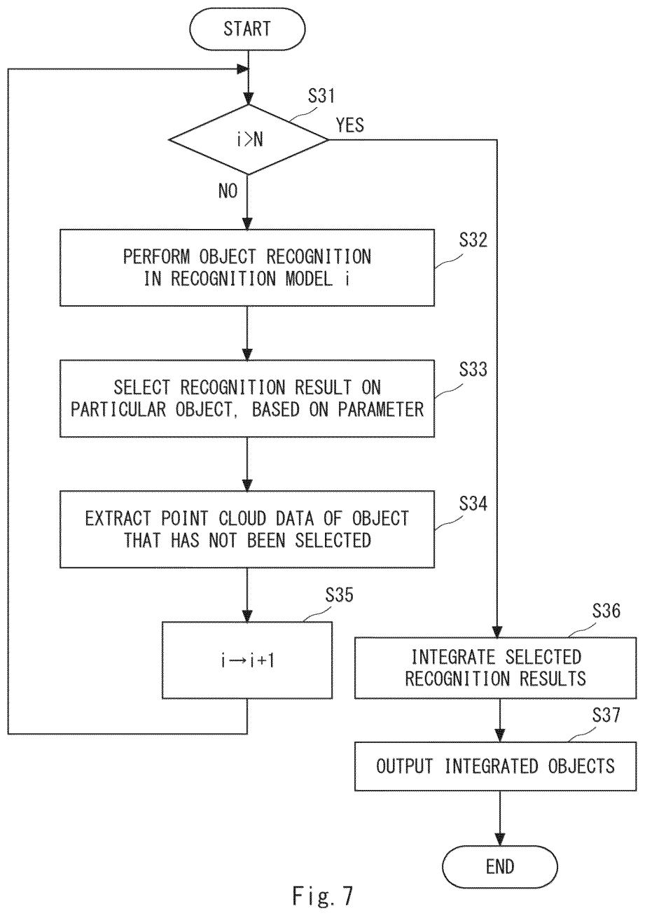

Subsequently, a flow of an object recognition process executed in the information processing device 30 will be described with reference to FIG. 7. It is assumed that the recognition process for the point cloud data input to the recognition unit 21 by the data input unit 24 is repeated sequentially from the recognition model_1 to the recognition model_N. It is also assumed that the selection unit 22 has a counter indicating the number of times the recognition process is executed. The selection unit 22 increments the counter every time the recognition process is executed.

First, the selection unit 22 verifies whether a value i of the counter exceeds N (S31). In a case where the selection unit 22 verifies that the value i of the counter does not exceed N, the recognition model i performs the recognition process on an object (S32). Upon verifying that the value i of the counter does not exceed N, the selection unit 22 may output, to the recognition model_i, the point cloud data of an object that has not been selected among the recognition results of the recognition model_i−1. An initial value of the value i of the counter may be one.

Next, the selection unit 22 selects a recognition result on a particular object, based on the parameter, from among the object recognition results of the recognition model_i (S33). The selection unit 22 outputs the selected recognition result to the generation unit 23.

Next, the selection unit 22 extracts the point cloud data of an object that has not been selected among the recognition results of the recognition model_i (S34). In other words, the selection unit 22 may generate point cloud data in which the point cloud relating to the selected object has been deleted among the recognition results of the recognition model_i.

Next, the selection unit 22 increments the value i of the counter to i+1 (S35). Next, the selection unit 22 returns to step S31 and verifies whether the new value i of the counter exceeds N.

In a case where the selection unit 22 verifies that the value i of the counter exceeds N in step S31, the generation unit 23 integrates the selected recognition results (S36). Integrating may be paraphrased as combining. The generation unit 23 generates recognition data by integrating the selected recognition results. Next, the output unit 26 outputs the recognition data to a display unit such as a display (S37).

As described above, the recognition model_1 to the recognition model_N included in the information processing device 30 perform the recognition process on an object, using the point cloud data obtained by excluding the point cloud data of the already selected object. Every time the recognition process is executed, the data amount of the point cloud data decreases. As a result, the processing load relating to the recognition process executed by the recognition models decreases every time the recognition process is executed.

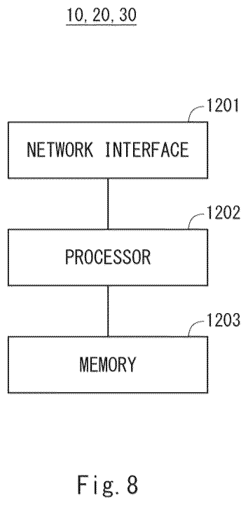

FIG. 8 is a block diagram illustrating a configuration example of the information processing devices 10 to 30 (hereinafter, referred to as the information processing device 10 and the like) described in the above example embodiments. Referring to FIG. 8, the information processing device 10 and the like include a network interface 1201, a processor 1202, and a memory 1203. The network interface 1201 may be used to communicate with network nodes. The network interface 1201 may include, for example, a network interface card (NIC) conforming to IEEE 802.3 series. The IEEE represents the Institute of Electrical and Electronics Engineers.

The processor 1202 performs the processes of a measuring device 20 described with reference to the flowcharts in the above example embodiments, by reading software (computer programs) from the memory 1203 and executing the read software. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage arranged away from the processor 1202. In this case, the processor 1202 may access the memory 1203 via an input/output (I/O) interface (not illustrated).

In the example in FIG. 8, the memory 1203 is used to store a group of software modules. The processor 1202 can perform a process of the information processing device 10 and the like described above in the example embodiments by reading and executing this group of software modules from the memory 1203.

As described with reference to FIG. 8, each of the processors included in the information processing device 10 and the like in the above-described example embodiments executes one or more programs including a group of commands for causing a computer to perform the algorithms described with reference to the drawings.

In the above-described example, the program includes a group of commands (or software codes) for causing a computer to perform one or more functions described in the example embodiments if the program is read by the computer. The program may be stored in a non-transitory computer-readable medium or a tangible storage medium. By way of example and not limitation, a computer-readable medium or tangible storage medium includes a random-access memory (RAM), a read-only memory (ROM), a flash memory, a solid-state drive (SSD) or other memory techniques, a compact disc read-only memory (CD-ROM), a digital versatile disc (DVD), a Blu-ray (registered trademark) disc, or other optical disc storages, and a magnetic cassette, a magnetic tape, a magnetic disk storage, or other magnetic storage devices. The program may be transmitted on a transitory computer-readable medium or a communication medium. By way of example and not limitation, the transitory computer-readable medium or the communication medium includes electrical, optical, or acoustic or any other form of propagated signals.

Note that the technical ideas of the present disclosure are not limited to the above example embodiments and can be modified as appropriate without departing from the scope.

Some or all of the example embodiments described above may also be described as, but are not limited to, the following Supplementary Notes.

### Supplementary Note 1

An information processing device including:
a recognition means for recognizing at least one object present in a predetermined space included in image data by using a first recognition model and a second recognition model;
a selection means for selecting which of a recognition result of the first recognition model and a recognition result of the second recognition model is to be used, for each of the objects; and
a generation means for generating recognition data including the selected recognition result on each of the objects,
in which the first recognition model recognizes the object, based on a positional relationship between the objects, while the second recognition model recognizes the object, based on a shape of the object.

### Supplementary Note 2

The information processing device according to Supplementary Note 1, in which the selection means
selects one of the first recognition model and the second recognition model, based on a feature of the object to be recognized.

### Supplementary Note 3

The information processing device according to Supplementary Note 1 or 2, in which the selection means
selects one of the first recognition model and the second recognition model, based on a dimension of the object to be recognized.

### Supplementary Note 4

The information processing device according to Supplementary Note 1 or 2, in which the selection means
selects one of the first recognition model and the second recognition model, based on an application of the object to be recognized.

### Supplementary Note 5

The information processing device according to Supplementary Note 1 or 2, in which the selection means
selects one of the first recognition model and the second recognition model, based on a ratio of a dimension of the object to a dimension of a facility included in the predetermined space.

### Supplementary Note 6

The information processing device according to any one of Supplementary Notes 1 to 5, in which the recognition means
processes the image data in parallel by using the first recognition model and the second recognition model to recognize the at least one object.

### Supplementary Note 7

The information processing device according to Supplementary Note 6, further including a data input means for inputting point cloud data to the first recognition model and the second recognition model, as the image data.

### Supplementary Note 8

The information processing device according to any one of Supplementary Notes 1 to 5, in which the recognition means
processes the image data in series by using the first recognition model and the second recognition model to recognize the at least one object.

### Supplementary Note 9

The information processing device according to Supplementary Note 8, further including a data input means for inputting point cloud data to the first recognition model or the second recognition model, as the image data, in which the recognition means
recognizes the at least one object present in the point cloud data by using one of the first recognition model and the second recognition model, and then recognizes the at least one object present in the point cloud data by using the other of the first recognition model and the second recognition model.

### Supplementary Note 10

An object recognizing method including:
recognizing at least one object present in a predetermined space included in image data by using a first recognition model and a second recognition model;
selecting which of a recognition result of the first recognition model and a recognition result of the second recognition model is to be used, for each of the objects; and
generating recognition data including the selected recognition result on each of the objects,
in which the first recognition model recognizes the object, based on a positional relationship between the objects, while the second recognition model recognizes the object, based on a shape of the object.

### Supplementary Note 11

The object recognizing method according to Supplementary Note 10, further including, in selecting the recognition result,
selecting one of the first recognition model and the second recognition model, based on a feature of the object to be recognized.

### Supplementary Note 12

The object recognizing method according to Supplementary Note 10 or 11, further including, in selecting the recognition result,
selecting one of the first recognition model and the second recognition model, based on a dimension of the object to be recognized.

### Supplementary Note 13

The object recognizing method according to Supplementary Note 10 or 11, further including, in selecting the recognition result,
selecting one of the first recognition model and the second recognition model, based on an application of the object to be recognized.

### Supplementary Note 14

The object recognizing method according to Supplementary Note 10 or 11, further including, in selecting the recognition result,
selecting one of the first recognition model and the second recognition model, based on a ratio of a dimension of the object to a dimension of a facility included in the predetermined space.

### Supplementary Note 15

The object recognizing method according to any one of Supplementary Notes 10 to 14, further including, in selecting the recognition result,
processing the image data in parallel by using the first recognition model and the second recognition model to recognize the at least one object.

### Supplementary Note 16

The object recognizing method according to Supplementary Note 15, further including, prior to recognizing the at least one object,
inputting point cloud data to the first recognition model and the second recognition model, as the image data.

### Supplementary Note 17

The object recognizing method according to any one of Supplementary Notes 10 to 14, further including, in selecting the recognition result,
processing the image data in series by using the first recognition model and the second recognition model to recognize the at least one object.

The object recognizing method according to Supplementary Note 17, further including:
inputting point cloud data to the first recognition model or the second recognition model, as the image data, prior to recognizing the at least one object; and
recognizing the at least one object present in the point cloud data by using one of the first recognition model and the second recognition model, and then recognizing the at least one object present in the point cloud data by using the other of the first recognition model and the second recognition model.

### Supplementary Note 19

A non-transitory computer-readable medium storing a program for causing a computer to execute:
recognizing at least one object present in a predetermined space included in image data by using a first recognition model and a second recognition model;
selecting which of a recognition result of the first recognition model and a recognition result of the second recognition model is to be used, for each of the objects; and
generating recognition data including the selected recognition result on each of the objects,
in which the first recognition model recognizes the object, based on a positional relationship between the objects, while the second recognition model recognizes the object, based on a shape of the object.

### REFERENCE SIGNS LIST

10 information processing device
11 recognition unit
12 selection unit
13 generation unit
20 information processing device
21 recognition unit
22 selection unit
23 generation unit
24 data input unit
26 output unit
30 information processing device

What is claimed is:

1. An information processing device comprising:
at least one memory storing instructions; and
at least one processor configured to execute the instructions to,
recognize at least one object present in a predetermined space included in image data by using a first recognition model and a second recognition model;
select which of a recognition result of the first recognition model and a recognition result of the second recognition model is to be used, for each of the objects; and
generation generate recognition data including the selected recognition result on each of the objects,
wherein the first recognition model recognizes the object, based on a positional relationship between the objects, while the second recognition model recognizes the object, based on a shape of the object.

2. The information processing device according to claim 1, wherein the at least one processor is further configured to execute the instructions to
select one of the first recognition model and the second recognition model, based on a feature of the object to be recognized.

3. The information processing device according to claim 1, or wherein the at least one processor is further configured to execute the instructions to
select one of the first recognition model and the second recognition model, based on a dimension of the object to be recognized.

4. The information processing device according to claim 1, wherein the at least one processor is further configured to execute the instructions to
select one of the first recognition model and the second recognition model, based on an application of the object to be recognized.

5. The information processing device according to claim 1, wherein the at least one processor is further configured to execute the instructions to
select one of the first recognition model and the second recognition model, based on a ratio of a dimension of the object to a dimension of a facility included in the predetermined space.

6. The information processing device according to claim 1, wherein the at least one processor is further configured to execute the instructions to
process the image data in parallel by using the first recognition model and the second recognition model to recognize the at least one object.

7. The information processing device according to claim 6, wherein the at least one processor is further configured to execute the instructions to input point cloud data to the first recognition model and the second recognition model, as the image data.

8. The information processing device according to claim 1, wherein the at least one processor is further configured to execute the instructions to
process the image data in series by using the first recognition model and the second recognition model to recognize the at least one object.

9. The information processing device according to claim 8, wherein the at least one processor is further configured to execute the instructions to input point cloud data to the first recognition model or the second recognition model, as the image data,
and recognize the at least one object present in the point cloud data by using one of the first recognition model and the second recognition model, and then recognizes the at least one object present in the point cloud data by using the other of the first recognition model and the second recognition model.

10. An object recognizing method comprising:
recognizing at least one object present in a predetermined space included in image data by using a first recognition model and a second recognition model;
selecting which of a recognition result of the first recognition model and a recognition result of the second recognition model is to be used, for each of the objects; and
generating recognition data including the selected recognition result on each of the objects,
wherein the first recognition model recognizes the object, based on a positional relationship between the objects, while the second recognition model recognizes the object, based on a shape of the object.

11. The object recognizing method according to claim 10, further comprising, in selecting the recognition result,
selecting one of the first recognition model and the second recognition model, based on a feature of the object to be recognized.

12. The object recognizing method according to claim 10, further comprising, in selecting the recognition result,
selecting one of the first recognition model and the second recognition model, based on a dimension of the object to be recognized.

13. The object recognizing method according to claim 10, further comprising, in selecting the recognition result,
selecting one of the first recognition model and the second recognition model, based on an application of the object to be recognized.

14. The object recognizing method according to claim 10, further comprising, in selecting the recognition result,
selecting one of the first recognition model and the second recognition model, based on a ratio of a dimension of the object to a dimension of a facility included in the predetermined space.

15. The object recognizing method according claim 10, further comprising, in selecting the recognition result,
processing the image data in parallel by using the first recognition model and the second recognition model to recognize the at least one object.

16. The object recognizing method according to claim 15, further comprising, prior to recognizing the at least one object,
inputting point cloud data to the first recognition model and the second recognition model, as the image data.

17. The object recognizing method according to claim 10, further comprising, in selecting the recognition result,
processing the image data in series by using the first recognition model and the second recognition model to recognize the at least one object.

18. The object recognizing method according to claim 17, further comprising:
inputting point cloud data to the first recognition model or the second recognition model, as the image data, prior to recognizing the at least one object; and
recognizing the at least one object present in the point cloud data by using one of the first recognition model and the second recognition model, and then recognizing the at least one object present in the point cloud data by using the other of the first recognition model and the second recognition model.

19. A non-transitory computer-readable medium storing a program for causing a computer to execute:
recognizing at least one object present in a predetermined space included in image data by using a first recognition model and a second recognition model;
selecting which of a recognition result of the first recognition model and a recognition result of the second recognition model is to be used, for each of the objects; and
generating recognition data including the selected recognition result on each of the objects,
wherein the first recognition model recognizes the object, based on a positional relationship between the objects, while the second recognition model recognizes the object, based on a shape of the object.
